(19) United States
(12) Patent Application Publication
(10) Pub. No.: US 2026/0279366 A1
(43) Pub. Date: Sep. 17, 2026

(54) AUDIO SIGNAL CODING METHOD AND APPARATUS, AND AUDIO SIGNAL DECODING METHOD AND APPARATUS

(71) Applicant: DOUYIN VISION CO., LTD., Beijing (CN)

(72) Inventors: Kunpeng LIN, Beijing (CN); Dejun ZHANG, Beijing (CN); Ziqian WU, Beijing (CN); Jiawei JIANG, Beijing (CN); He WANG, Beijing (CN); Yijian XIAO, Beijing (CN); Piao DING, Beijing (CN); Shenyi SONG, Beijing (CN)

(21) Appl. No.: 18/875,714

(22) PCT Filed: Oct. 31, 2023
(86) PCT No.: PCT/CN2023/128523

§ 371 Date: Dec. 16, 2024

(30) Foreign Application Priority Data
Nov. 1, 2022 (CN) 202211357728.0

(51) Int. Cl. G10L 19/02; G10L 19/06; G10L 19/26

(52) U.S. Cl. CPC G10L 19/0204; G10L 19/06; G10L 19/265

(57) ABSTRACT

An audio signal encoding method and apparatus, and an audio signal decoding method and apparatus. The audio signal encoding method includes: acquiring a high-frequency residual signal and a low-frequency residual signal of a target audio frame; suppressing a frequency component in the low-frequency residual signal within a target frequency range to acquire an encoded suppression signal, where a center frequency of the target frequency range is a fundamental-tone frequency of the low-frequency residual signal; performing spectrum inversion on the encoded suppression signal to acquire a spectrum inversion signal; acquiring a high-frequency energy gain of the target audio signal according to the spectrum inversion signal and the high-frequency residual signal; and generating encoded data of the target audio frame according to the high-frequency energy gain.

### CROSS-REFERENCE TO RELATED APPLICATION(S)

This application claims priority to Chinese Application No. 202211357728.0, filed in CNIPA on Nov. 1, 2022, and entitled “Audio Signal Encoding Method and Apparatus, and Audio Signal Decoding Method and Apparatus”, the disclosure of which is incorporated herein by reference in its entity.

### FIELD

The present application relates to the technical field of data processing, and in particular to an audio signal encoding method and apparatus, and an audio signal decoding method and apparatus.

### BACKGROUND

During audio signal processing, a bandwidth extension algorithm may encode, using most code rates, low-frequency signals to which human ears are more sensitive under the limitation of the code rates, while high-frequency signals to which the human ears pay less attention are transmitted with fewer code rates, or the high-frequency signals are merely restored on a decoding end according to decoded low-frequency signals, to improve the quality of the overall encoded speech under a fixed code rate.

In the prior art, during audio signal processing, the spectra of the high-frequency signals are generally generated by folding the spectra of the low-frequency signals, so that restored audio frame signals lack part of harmonic components, and in order to suppress fundamental-tone components folded to high frequency, high-frequency energy is attenuated when the energy of the high-frequency signals is restored on the decoding end, such that the restored high-frequency energy is relatively low, and the overall listening feeling of audio frames is poor.

### SUMMARY

In view of this, embodiments of the present application provide an audio signal encoding method and apparatus, and an audio signal decoding method and apparatus, to improve audio quality after audio signal processing.

To achieve the above objectives, the embodiments of the present application provide the following technical solutions:
In a first aspect, an embodiment of the present application provides an audio signal encoding method, including:
acquiring a high-frequency residual signal and a low-frequency residual signal of a target audio frame;
suppressing a frequency component in the low-frequency residual signal within a target frequency range to acquire an encoded suppression signal, wherein a center frequency of the target frequency range is a fundamental-tone frequency of the low-frequency residual signal;
performing spectrum inversion on the encoded suppression signal to acquire a spectrum inversion signal;
acquiring a high-frequency energy gain of the target audio signal according to the spectrum inversion signal and the high-frequency residual signal; and
generating encoded data of the target audio frame according to the high-frequency energy gain.

As an optional implementation of the embodiment of the present application, suppressing the frequency component in the low-frequency residual signal within the target frequency range to acquire the encoded suppression signal includes:
performing pre-emphasis processing on the low-frequency residual signal based on a high-pass filter to suppress the frequency component in the low-frequency residual signal within the target frequency range, to acquire the encoded suppression signal.

As an optional implementation of the embodiment of the present application, suppressing the frequency component in the low-frequency residual signal within the target frequency range to acquire the encoded suppression signal includes:
performing filtering processing on the low-frequency residual signal based on a slope filter to suppress the frequency component in the low-frequency residual signal within the target frequency range, to acquire the encoded suppression signal.

As an optional implementation of the embodiment of the present application, suppressing the frequency component in the low-frequency residual signal within the target frequency range to acquire the encoded suppression signal includes:
performing notch processing on the frequency component within the target frequency range based on a second-order notch filter, to acquire an encoded notch signal; and
performing whitening processing on the encoded notch signal to acquire the encoded suppression signal.

As an optional implementation of the embodiment of the present application, performing spectrum inversion on the encoded suppression signal to acquire the spectrum inversion signal includes:
modifying an amplitude of a sampling point with an odd index in the encoded suppression signal into its opposite value to acquire the spectrum inversion signal.

As an optional implementation of the embodiment of the present application, acquiring the high-frequency residual signal and the low-frequency residual signal of the target audio frame includes:
performing frequency division on the target audio frame to obtain a low-frequency signal and a high-frequency signal;
performing linear prediction analysis on the high-frequency signal to acquire a first linear prediction coefficient (LPC);
converting the first linear prediction coefficient into a line spectrum pair (LSP) coefficient;
restoring the line spectrum pair coefficient to a second linear prediction coefficient;
evenly dividing the high-frequency signal into a preset number of sub-signals;
separately performing filtering processing on each sub-signal based on the second linear prediction coefficient to acquire a residual signal of each sub-signal, to acquire the high-frequency residual signal; and
encoding the low-frequency signal to acquire low-frequency encoding information and the low-frequency residual signal.

As an optional implementation of the embodiment of the present application, generating the encoded data of the target audio frame according to the high-frequency energy gain includes:
encoding the low-frequency encoding information, the line spectrum pair coefficient and the high-frequency energy gain to generate the encoded data of the target audio frame.

In a second aspect, an embodiment of the present application provides an audio signal decoding method, including:
parsing encoded data of a target audio frame to acquire low-frequency encoding information;
decoding the low-frequency encoding information to acquire a low-frequency signal and a low-frequency residual signal;
suppressing a frequency component in the low-frequency residual signal within a target frequency range to acquire a decoded suppression signal, wherein a center frequency of the target frequency range is a fundamental-tone frequency of the low-frequency residual signal;
performing spectrum inversion on the decoded suppression signal to acquire a low-frequency excitation signal;
performing signal reconstruction according to the low-frequency excitation signal to acquire a high-frequency signal; and
generating an audio signal of the target audio frame according to the low-frequency signal and the high-frequency signal.

As an optional implementation of the embodiment of the present application, suppressing the frequency component in the low-frequency residual signal within the target frequency range to acquire the decoded suppression signal includes:
performing pre-emphasis processing on the low-frequency residual signal based on a high-pass filter to suppress the frequency component in the low-frequency residual signal within the target frequency range, to acquire the decoded suppression signal.

As an optional implementation of the embodiment of the present application, suppressing the frequency component in the low-frequency residual signal within the target frequency range to acquire the decoded suppression signal includes:
performing filtering processing on the low-frequency residual signal based on a slope filter to suppress the frequency component in the low-frequency residual signal within the target frequency range, to acquire the decoded suppression signal.

As an optional implementation of the embodiment of the present application, suppressing the frequency component in the low-frequency residual signal within the target frequency range to acquire the decoded suppression signal includes:
performing notch processing on the frequency component within the target frequency range based on a second-order notch filter, to acquire a decoded notch signal; and
performing whitening processing on the decoded notch signal to acquire the decoded suppression signal.

As an optional implementation of the embodiment of the present application, performing spectrum inversion on the decoded suppression signal to acquire the low-frequency excitation signal includes:
modifying an amplitude of a sampling point with an odd index in the decoded suppression signal into its opposite value to acquire a spectrum inversion signal.

As an optional implementation of the embodiment of the present application, the encoded data of the target audio frame further includes an LSP coefficient and a high-frequency energy gain;
wherein performing signal reconstruction according to the low-frequency excitation signal to acquire the high-frequency signal includes:
performing signal reconstruction according to the low-frequency excitation signal, the LSP coefficient and the high-frequency energy gain, to acquire the high-frequency signal.

As an optional implementation of the embodiment of the present application, performing signal reconstruction according to the low-frequency excitation signal, the LSP coefficient and the high-frequency energy gain, to acquire the high-frequency signal, includes:
acquiring an energy gain corresponding to each sub-signal in the high-frequency energy gain;
acquiring a residual signal of each sub-signal according to the low-frequency excitation signal and the energy gain of each sub-signal;
restoring the LSP coefficient to an LPC;
acquiring each prediction sub-signal according to the LPC;
generating each sub-signal according to each prediction sub-signal and the residual signal of each sub-signal; and
generating the high-frequency signal according to each sub-signal.

In a third aspect, an embodiment of the present application provides an audio signal encoding apparatus, including:
an acquisition unit, configured to acquire a high-frequency residual signal and a low-frequency residual signal of a target audio frame;
a suppression unit, configured to suppress a frequency component in the low-frequency residual signal within a target frequency range to acquire an encoded suppression signal, wherein a center frequency of the target frequency range is a fundamental-tone frequency of the low-frequency residual signal;
an inversion unit, configured to perform spectrum inversion on the encoded suppression signal to acquire a spectrum inversion signal;
a processing unit, configured to acquire a high-frequency energy gain of the target audio signal according to the spectrum inversion signal and the high-frequency residual signal; and
a generation unit, configured to generate encoded data of the target audio frame according to the high-frequency energy gain.

As an optional implementation of the embodiment of the present application, the suppression unit is specifically configured to perform pre-emphasis processing on the low-frequency residual signal based on a high-pass filter to suppress the frequency component in the low-frequency residual signal within the target frequency range, to acquire the encoded suppression signal.

As an optional implementation of the embodiment of the present application, the suppression unit is specifically configured to perform filtering processing on the low-frequency residual signal based on a slope filter to suppress the frequency component in the low-frequency residual signal within the target frequency range, to acquire the encoded suppression signal.

As an optional implementation of the embodiment of the present application, the suppression unit is specifically configured to perform notch processing on the frequency component within the target frequency range based on a second-order notch filter to acquire an encoded notch signal, and perform whitening processing on the encoded notch signal to acquire the encoded suppression signal.

As an optional implementation of the embodiment of the present application, the inversion unit is specifically configured to modify an amplitude of a sampling point with an odd index in the encoded suppression signal into its opposite value to acquire the spectrum inversion signal.

As an optional implementation of the embodiment of the present application, the acquisition unit is specifically configured to:
perform frequency division on the target audio frame to obtain a low-frequency signal and a high-frequency signal;
perform linear prediction analysis on the high-frequency signal to acquire a first linear prediction coefficient (LPC);
convert the first linear prediction coefficient into a line spectrum pair (LSP) coefficient;
restore the line spectrum pair coefficient to a second linear prediction coefficient;
evenly divide the high-frequency signal into a preset number of sub-signals;
separately perform filtering processing on each sub-signal based on the second linear prediction coefficient to acquire a residual signal of each sub-signal, to acquire the high-frequency residual signal; and
encode the low-frequency signal to acquire low-frequency encoding information and the low-frequency residual signal.

As an optional implementation of the embodiment of the present application, the generation unit is specifically configured to encode the low-frequency encoding information, the line spectrum pair coefficient and the high-frequency energy gain to generate the encoded data of the target audio frame.

In a fourth aspect, an embodiment of the present application provides an audio signal decoding apparatus, including:
an acquisition unit, configured to parse encoded data of a target audio frame to acquire low-frequency encoding information;
a decoding unit, configured to decode the low-frequency encoding information to acquire a low-frequency signal and a low-frequency residual signal;
a suppression unit, configured to suppress a frequency component in the low-frequency residual signal within a target frequency range to acquire a decoded suppression signal, wherein a center frequency of the target frequency range is a fundamental-tone frequency of the low-frequency residual signal;
an inversion unit, configured to perform spectrum inversion on the decoded suppression signal to acquire a low-frequency excitation signal;
a reconstruction unit, configured to perform signal reconstruction according to the low-frequency excitation signal to acquire a high-frequency signal; and
a generation unit, configured to generate an audio signal of the target audio frame according to the low-frequency signal and the high-frequency signal.

As an optional implementation of the embodiment of the present application, the suppression unit is specifically configured to perform pre-emphasis processing on the low-frequency residual signal based on a high-pass filter to suppress the frequency component in the low-frequency residual signal within the target frequency range, to acquire the decoded suppression signal.

As an optional implementation of the embodiment of the present application, the suppression unit is specifically configured to perform filtering processing on the low-frequency residual signal based on a slope filter to suppress the frequency component in the low-frequency residual signal within the target frequency range, to acquire the decoded suppression signal.

As an optional implementation of the embodiment of the present application, the suppression unit is specifically configured to perform notch processing on the frequency component within the target frequency range based on a second-order notch filter to acquire an encoded notch signal, and perform whitening processing on the decoded notch signal to acquire the decoded suppression signal.

As an optional implementation of the embodiment of the present application, the inversion unit is specifically configured to modify an amplitude of a sampling point with an odd index in the decoded suppression signal into its opposite value to acquire a low-frequency excitation signal.

As an optional implementation of the embodiment of the present application, the encoded data of the target audio frame further includes an LSP coefficient and a high-frequency energy gain, and the reconstruction unit is specifically configured to perform signal reconstruction according to the low-frequency excitation signal, the LSP coefficient and the high-frequency energy gain, to acquire the high-frequency signal.

As an optional implementation of the embodiment of the present application, the reconstruction unit is specifically configured to acquire an energy gain corresponding to each sub-signal in the high-frequency energy gain; acquire a residual signal of each sub-signal according to the low-frequency excitation signal and the energy gain of each sub-signal; restore the LSP coefficient to an LPC; acquire each prediction sub-signal according to the LPC; generate each sub-signal according to each prediction sub-signal and the residual signal of each sub-signal; and generate the high-frequency signal according to each sub-signal.

In a fifth aspect, an embodiment of the present application provides an electronic device, including a memory and a processor, wherein the memory is configured to store a computer program; and the processor is configured to, when executing the computer program, cause the electronic device to implement the audio signal encoding method or the audio signal decoding method in any of the above implementations.

In a sixth aspect, an embodiment of the present application provides a computer-readable storage medium, wherein when a computer program is executed by a computing device, the computing device is caused to implement the audio signal encoding method or the audio signal decoding method in any of the above implementations.

In a seventh aspect, an embodiment of the present application provides a computer program product, wherein when the computer program product runs on a computer, the computer is caused to implement the audio signal encoding method or the audio signal decoding method in any of the above implementations.

In the audio signal encoding method provided in the embodiment of the present application, the high-frequency residual signal and the low-frequency residual signal of the target audio frame are acquired, the frequency component in the low-frequency residual signal within the target frequency range is suppressed to acquire the encoded suppression signal, spectrum inversion is performed on the encoded suppression signal to acquire the spectrum inversion signal, then the high-frequency energy gain of the target audio signal is acquired according to the spectrum inversion signal and the high-frequency residual signal, and finally, the encoded data of the target audio frame is generated according to the high-frequency energy gain. In the embodiment of the present application, by suppressing and inverting the frequency component of the acquired low-frequency residual signal, and then obtaining the encoded data of the target audio frame in combination with the high-frequency residual signal and the high-frequency energy gain, it is ensured that the problems of lacking a harmonic component and having relatively low energy will not occur in a reconstructed high-frequency signal. In this way, it is possible to avoid the problem of poor audio quality when bitstream data of the target audio frame is acquired, thereby improving the user experience. Therefore, in the embodiment of the present application, the audio quality can be improved during encoding and decoding processes.

### BRIEF DESCRIPTION OF THE DRAWINGS

The drawings herein are incorporated in and constitute a part of the present specification, illustrate embodiments conforming to the present application, and serve to explain the principles of the present application together with the specification.

To illustrate technical solutions in the embodiments of the present application or in the prior art more clearly, a brief introduction on the drawings which are needed in the description of the embodiments or the prior art is given below. Apparently, for those ordinary skilled in the art, other drawings may also be obtained according to these drawings without creative efforts.

FIG. 1 is a first flowchart of an audio signal encoding method provided in an embodiment of the present application;

FIG. 2 is a second flowchart of an audio signal encoding method provided in an embodiment of the present application;

FIG. 3 is a third flowchart of an audio signal encoding method provided in an embodiment of the present application;

FIG. 4 is a fourth flowchart of an audio signal encoding method provided in an embodiment of the present application;

FIG. 5 is a hardware block diagram of an audio signal encoding device provided in an embodiment of the present application;

FIG. 6 is a first flowchart of an audio signal decoding method provided in an embodiment of the present application;

FIG. 7 is a second flowchart of an audio signal decoding method provided in an embodiment of the present application;

FIG. 8 is a third flowchart of an audio signal decoding method provided in an embodiment of the present application;

FIG. 9 is a fourth flowchart of an audio signal decoding method provided in an embodiment of the present application;

FIG. 10 is a hardware block diagram of an audio signal decoding device provided in an embodiment of the present application;

FIG. 11 is a schematic structural diagram of an audio signal encoding apparatus provided in an embodiment of the present application;

FIG. 12 is a schematic structural diagram of an audio signal decoding apparatus provided in an embodiment of the present application; and

FIG. 13 is a schematic structural diagram of an electronic device provided in an embodiment of the present application.

### DETAILED DESCRIPTION OF EMBODIMENTS

In order to understand the above objectives, features and advantages of the present application more clearly, the solutions of the present application will be further described below. It should be noted that, in the case of no conflict, the embodiments of the present application and the features in the embodiments may be combined with each other.

In the following description, numerous specific details are set forth to fully understand the present application, but the present application may also be implemented in other manners different from those described herein; and obviously, the embodiments in the specification are only a part, but not all, of the embodiments of the present application.

In the embodiments of the present application, words such as “exemplary” or “for example” are used to represent giving an example, an illustration or a description. Any embodiment or design scheme described as “exemplary” or “for example” in the embodiments of the present application should not be explained as being more preferred or more advantageous than other embodiments or design schemes. Exactly, the words such as “exemplary” or “for example” are invoked to present related concepts in a specific manner. In addition, in the description of the embodiments of the present application, unless otherwise specified, “a plurality of” means two or more.

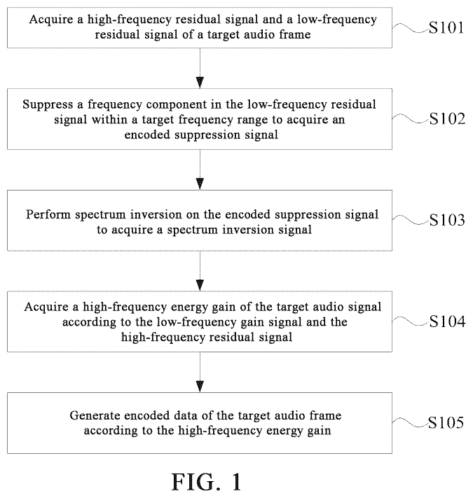

An embodiment of the present application provides an audio signal encoding method, and as shown in FIG. 1, the audio signal encoding method includes the following steps:

S101: acquiring a high-frequency residual signal and a low-frequency residual signal of a target audio frame.

The high-frequency residual signal refers to a difference value between a value of each sample point of a high-frequency signal of an audio signal and a corresponding predicted value, and the predicted value corresponding to each sample point is a product of a linear prediction coefficient (LPC) and a low-frequency signal of a historical audio signal; and the low-frequency residual signal refers to a difference value between a value of each sample point of a low-frequency signal of the audio signal and a corresponding predicted value, and the predicted value corresponding to each sample point is a product of the linear prediction coefficient and the low-frequency signal of the historical audio signal. The linear prediction coefficient refers to that the sample point values of the audio signal may be approximated by a linear combination in which the sample point values of historical audio data are multiplied by coefficients and the products are summated, for example, in a case where an LPC order is 10, then there are 10 coefficients, the 10 coefficients are separately multiplied by 10 sample point values of the historical audio data, and the products are summated to approximate the current sample point value, and these coefficients are linear prediction coefficients.

The manner of obtaining the high-frequency residual signal and the low-frequency residual signal may be the same as that in the prior art, and the implementation of acquiring the high-frequency residual signal and the low-frequency residual signal of the target audio frame is not limited in the embodiment of the present application, as long as the high-frequency residual signal and the low-frequency residual signal of the target audio frame may be acquired.

S102: suppressing a frequency component in the low-frequency residual signal within a target frequency range to acquire an encoded suppression signal.

A center frequency of the target frequency range is a fundamental-tone frequency of the low-frequency residual signal.

The fundamental-tone frequency is also referred to as a fundamental frequency or a baseband, which refers to the frequency of a fundamental tone in one complex tone. In several tones constituting one complex tone, the fundamental tone has the minimum frequency and the maximum intensity. The magnitude of the fundamental frequency determines the pitch of a tone.

Exemplarily, when the center frequency of the target frequency range is 20 Khz, the target frequency range may be {10 Khz, 30 Khz}; and when the center frequency of the target frequency range is 40 Khz, the target frequency range may be {20 Khz, 60 Khz}.

S103: performing spectrum inversion on the encoded suppression signal to acquire a spectrum inversion signal.

The shape of a sampling baseband spectrum (the center frequency thereof is in the vicinity of 0 Hz) obtained according to a bandpass sampling theorem formula is just opposite to the shapes of positive and negative spectra of an original signal, so performing the spectrum inversion on the encoded suppression signal in the embodiment of the present application is to make the shapes of positive and negative spectra of the spectrum inversion signal be opposite to those of the positive and negative spectra of the encoded suppression signal.

S104: acquiring a high-frequency energy gain of the target audio signal according to the spectrum inversion signal and the high-frequency residual signal.

The high-frequency energy gain refers to an energy gain of the high-frequency residual signal, and specifically, an energy ratio gain value between the high-frequency residual signal and the low-frequency residual signal refers to an energy offset value between the high-frequency signal and the low-frequency signal.

In some embodiments, the implementation of acquiring the high-frequency energy gain of the target audio signal according to the spectrum inversion signal and the high-frequency residual signal may include:
acquiring an energy value of the spectrum inversion signal and an energy value of the high-frequency residual signal, and calculating a ratio of the energy value of the spectrum inversion signal to the energy value of the high-frequency residual signal, to acquire the high-frequency energy gain of the target audio signal.

S105: generating encoded data of the target audio frame according to the high-frequency energy gain.

In the audio signal encoding method provided in the embodiment of the present application, the high-frequency residual signal and the low-frequency residual signal of the target audio frame are acquired, the frequency component in the low-frequency residual signal within the target frequency range is suppressed to acquire the encoded suppression signal, the frequency component meeting a preset condition in the encoded suppression signal is inverted to acquire the spectrum inversion signal, then the high-frequency energy gain of the target audio signal is acquired according to the spectrum inversion signal and the high-frequency residual signal, and finally, the encoded data of the target audio frame is generated according to the high-frequency energy gain. In the embodiment of the present application, by suppressing and inverting the frequency component of the acquired low-frequency residual signal, it is ensured that the problems of lacking a harmonic component and having relatively low energy will not occur in a reconstructed high-frequency signal. In this way, it is possible to avoid the problem of poor audio quality when bitstream data of the target audio frame is acquired, thereby improving the user experience. Therefore, in the embodiment of the present application, the audio quality may be improved during an encoding process.

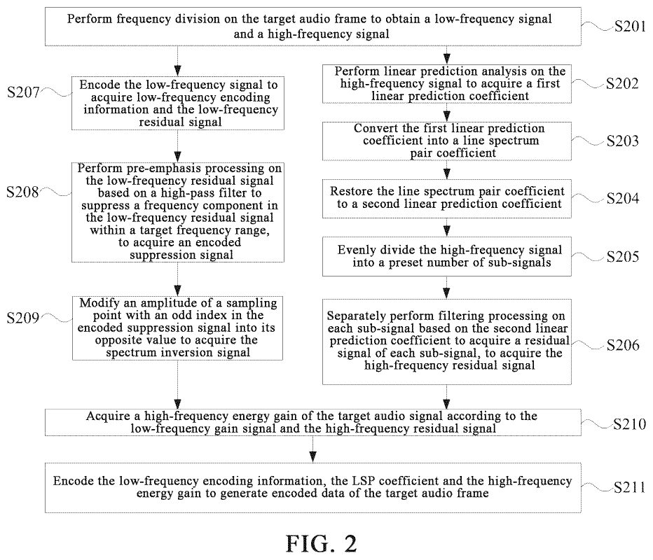

As extension and refinement of the above embodiments, an embodiment of the present application provides another audio signal encoding method, and as shown in FIG. 2, the audio signal encoding method includes the following steps:

S201: performing frequency division on the target audio frame to obtain a low-frequency signal and a high-frequency signal.

In some embodiments, frequency division may be performed on the target audio frame by a quadrature mirror filter (QMF) to obtain the low-frequency signal and the high-frequency signal. The frequency range of the low-frequency signal may be [0 KHz-4 KHz], and the frequency range of the high-frequency signal may be [4 KHz-8 KHz].

S202: performing linear prediction analysis on the high-frequency signal to acquire a first linear prediction coefficient.

In some embodiments, linear prediction analysis may be performed on the high-frequency signal by a burg algorithm to acquire the first linear prediction coefficient. The burg algorithm is a recursive algorithm that calculates a power spectrum estimation value directly from a known time signal sequence.

S203: converting the first linear prediction coefficient into a line spectrum pair (LSP) coefficient.

The implementation of converting the first linear prediction coefficient into the line spectrum pair coefficient may be the same as the implementation of converting the LPC into the LSP coefficient in the prior art, which is not limited in the embodiment of the present application.

S204: restoring the line spectrum pair coefficient to a second linear prediction coefficient.

Similarly, the implementation of restoring the line spectrum pair coefficient to the second linear prediction coefficient may be the same as the implementation of restoring the LSP coefficient to the LPC in the prior art, which is not limited in the embodiment of the present application.

S205: evenly dividing the high-frequency signal into a preset number of sub-signals.

The preset number is not limited in the embodiment of the present application, and the high-frequency signal may be evenly divided into any number of sub-signals as needed during an actual encoding process. For example, the high-frequency signal may be divided into four sub-signals with equal lengths, and as another example, the high-frequency signal is divided into eight sub-signals with equal lengths.

S206: separately performing filtering processing on each sub-signal based on the second linear prediction coefficient to acquire a residual signal of each sub-signal and acquire the high-frequency residual signal.

Specifically, a transfer function of a linear prediction filter for separately performing the filtering processing on each sub-signal based on the second linear prediction coefficient may be:

$$A ( z ) = 1 - {\sum }_{i = 1}^{8} {a}_{i} {z}^{- 1}$$

The residual signal of the sub-signal obtained by the transfer function is:

$${res}_{hb} ( n ) = {x}_{hb} ( n ) - {\sum }_{i = 1}^{8} {a}_{i} * {x}_{hb} ( n - i )$$

where i is an index of the sub-signal, x_{hb} represents an original sub-signal, aᵢ is the linear prediction coefficient of a sub-signal with an index of i, and res_{hb} is the residual signal of the sub-signal with the index of i.

S207: encoding the low-frequency signal to acquire low-frequency encoding information and the low-frequency residual signal.

In some embodiments, the low-frequency signal may be encoded by an SILK encoder to acquire the low-frequency encoding information and the low-frequency residual signal.

S208: performing pre-emphasis processing on the low-frequency residual signal based on a high-pass filter to suppress a frequency component in the low-frequency residual signal within a target frequency range, to acquire an encoded suppression signal.

Specifically, since the pre-emphasis processing is also a filtering processing, when the pre-emphasis processing is performed on each sub-signal based on the second linear prediction coefficient, the pre-emphasis processing is performed by using the high-pass filter, and the high-pass filter is used for suppressing a frequency component protruding near a fundamental-tone frequency, the transfer function of the high-pass filter is: H(z)=1−μz⁻¹, where μ is a preset filtering coefficient.

By using a difference equation, it is expressed as:

$${res}_{lb}^{\hat{}} ( n ) = {res}_{lb} ( n ) - μ * {res}_{lb} ( n - 1 )$$

where

$${res}_{lb}^{\hat{}} ( n )$$

represents the processed low-frequency residual signal, μ is a preset filtering coefficient, μ determines a suppression degree of a frequency component with a lower frequency and an emphasis degree of a frequency component with a higher frequency in the low-frequency residual signal, the greater the value of is, the higher the suppression degree of the frequency component with the lower frequency is, and the higher the emphasis degree of the frequency component with the higher frequency is.

S209: modifying an amplitude of a sampling point with an odd index in the encoded suppression signal into its opposite value to acquire a spectrum inversion signal.

After frequency division is performed on an audio signal of the target audio frame by the quadrature mirror filter, the spectrum of the obtained high-frequency signal is inverted. Thus, in order to ensure that the spectrum of the spectrum inversion signal corresponds to the spectrum of the original high-frequency signal, it is necessary to perform spectrum inversion on the encoded suppression signal.

An opposite number is obtained for the sampling point with an odd index in the encoded suppression signal, to acquire the spectrum inversion signal. Specifically, the spectrum inversion signal may be acquired by the following formula and the encoded suppression signal:

$${res}_{lb} ( i ) = {res}_{lb} ( i ) * {( - 1 )}^{i}$$

where i is the index of the sampling point in the encoded suppression signal. For example, when the index of the sampling point in the encoded suppression signal is 1, that is, i=1, the formula is recorded as: res_{lb}(1)=res_{lb}(1)*(−1)¹ to obtain res_{lb}(1)=−res_{lb}(1), which indicates that when i=1, the corresponding sampling point with an index of 1 in the obtained spectrum inversion signal is an opposite number of the sampling point with the index of 1 in the encoded suppression signal; and when the index of the sampling point in the encoded suppression signal is 2, that is, i=2, the formula is recorded as res_{lb}(2)=res_{lb}(2)*(−1)² to obtain res_{lb}(2)=res_{lb}(2)), which indicates that when i=2, the corresponding sample point with an index of 2 in the obtained spectrum inversion signal is equal to the sampling point with the index of 2 in the encoded suppression signal.

Exemplarily, in a case where the encoded suppression signal is {a₁, a₂, a₃, . . . a₆₄}, then the spectrum inversion signal calculated by the above formula is {−a₁, a₂, −a₃, . . . a₆₄}.

S210: acquiring a high-frequency energy gain of the target audio signal according to the spectrum inversion signal and the high-frequency residual signal.

The high-frequency energy gain includes an energy gain of each sub-signal.

In some embodiments, the energy gain value of the sub-signal with the index of i is:

$${gain}_{i} = \frac{{\sum }_{j = 1}^{N} {res}_{hb}^{2}}{{\sum }_{j = 1}^{N} {res}_{lb}^{2}}$$

where N is the length of the sub-signal, gainᵢ is the energy gain value of the sub-signal with the index of i,

$${res}_{hb}^{2}$$

is the energy of the spectrum inversion signal, and

$${res}_{lb}^{2}$$

is the energy of the sub-signal with the index of i.

S211: encoding the low-frequency encoding information, the LSP coefficient and the high-frequency energy gain to generate encoded data of the target audio frame.

That is, an audio signal packet is encapsulated for the low-frequency encoding information, the LSP coefficient and the high-frequency energy gain, to acquire the encoded data of the target audio frame.

In some embodiments, the audio signal encoding method provided in the embodiment of the present application further includes: before generating the encoded data of the target audio frame according to the low-frequency encoding information, the LSP coefficient and the high-frequency energy gain, performing dual-codebook quantization on the LSP coefficient.

For example, dual-codebook quantization is first performed on the LSP coefficient, and then a subscript of the corresponding codebook is encoded into a main code stream by using 12 bits.

The dual-codebook quantization is to perform coefficient retrieval on the obtained LSP coefficient by two different codebooks to obtain LSP coefficients and subscript codes of corresponding codebooks, and to synthesize a new LSP coefficient subscript code by retrieving the two codebooks.

A correspondence between dual-codebook encoding subscripts and LSP coefficients may be shown in Table 1 below:

TABLE 1

| | |
|---|---|
| Codebook 1 | Codebook 2 |

| | | | |
|---|---|---|---|
| 1111 | A₁B₁ | A₁B₁ | C₁ |
| 1112 | A₂B₂ | A₂B₂ | C₂ |
| 1113 | A₃B₃ | A₃B₃ | C₃ |
| 1114 | A₄B₄ | A₄B₄ | C₄ |
| 1115 | A₅B₅ | A₅B₅ | C₅ |
| 1116 | A₆B₆ | A₆B₆ | C₆ |
| 1117 | A₇B₇ | A₇B₇ | C₇ |
| 1118 | A₈B₈ | A₈B₈ | C₈ |

In a case where the correspondence between the dual-codebook encoding subscripts and the LSP coefficients are shown in the above Table 1, when the LSP coefficients are {1111, 1112, 1113, 1115, 1117, 1118, 1119}, the corresponding codebook subscript codes obtained by the dual-codebook quantization are {C₁, C₂, C₃, C₄, C₅, C₆, C₇, C₈}.

By performing dual-codebook quantization on the LSP coefficient, the data volume of the LSP coefficient can be reduced, thereby improving the transmission efficiency of audio signals.

In some embodiments, the audio signal encoding method provided in the embodiment of the present application further includes: before generating the encoded data of the target audio frame according to the low-frequency encoding information, the LSP coefficient and the high-frequency energy gain, performing codebook quantization on the high-frequency energy gain.

For example, after the high-frequency energy gain is quantized, the corresponding subscripts may be encoded into the main code stream by using 5 bits, and when four sub-signals are included, the encoded data of the high-frequency energy gain consumes 20 bits in total.

A correspondence between encoding subscripts and high-frequency energy gains may be shown in the following Table 2:

TABLE 2
Codebook 3

| | |
|---|---|
| 2221 | D₁E₁ |
| 2222 | D₂E₂ |
| 2223 | D₃E₃ |
| 2224 | D₄E₄ |
| 2225 | D₅E₅ |
| 2226 | D₆E₆ |
| 2227 | D₇E₇ |
| 2228 | D₈E₈ |

By performing codebook quantization on the high-frequency energy gain, the data volume of the high-frequency energy gain can be reduced, thereby improving the transmission efficiency of audio signals.

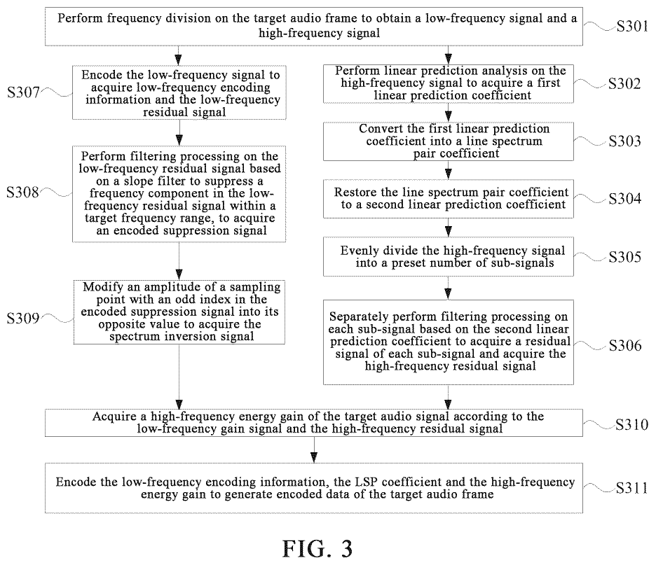

An embodiment of the present application provides another audio signal encoding method, and as shown in FIG. 3, the audio signal encoding method includes the following steps:

S301: performing frequency division on the target audio frame to obtain a low-frequency signal and a high-frequency signal.

S302: performing linear prediction analysis on the high-frequency signal to acquire a first linear prediction coefficient.

S303: converting the first linear prediction coefficient into a line spectrum pair coefficient.

S304: restoring the line spectrum pair coefficient to a second linear prediction coefficient.

S305: evenly dividing the high-frequency signal into a preset number of sub-signals.

S306: separately performing filtering processing on each sub-signal based on the second linear prediction coefficient to acquire a residual signal of each sub-signal, to acquire the high-frequency residual signal.

S307: encoding the low-frequency signal to acquire low-frequency encoding information and the low-frequency residual signal.

The implementations of the above steps S301 to S307 may be the same as the implementations of the steps S201 to S207 in the embodiment shown in FIG. 2, and thus details are not described herein again to avoid repetition.

S308: performing filtering processing on the low-frequency residual signal based on a slope filter to suppress a frequency component in the low-frequency residual signal within a target frequency range, to acquire an encoded suppression signal.

That is, filtering processing is performed on the low-frequency residual signal by a slope filter to suppress the frequency component within the target frequency range, where a center frequency of the target frequency range is a fundamental-tone frequency of the low-frequency residual signal.

In some embodiments, a transfer function of the slope filter may be as follows:

$$H ( z ) = \frac{( ( 1 + {B}_{0} ) tan \frac{π {f}_{c}}{{f}_{s}} + 1 ) + ( 1 + {B}_{0} ) tan \frac{π {f}_{c}}{{f}_{s}} - 1 ) {z}^{- 1} )}{( tan \frac{π {f}_{c}}{{f}_{s}} + 1 ) + ( tan \frac{π {f}_{c}}{{f}_{s}} - 1 ) {z}^{- 1}}$$

By using a difference equation, it is represented as:

$${res}_{lb}^{\hat{}} ( n ) = {b}_{0} * {res}_{lb} ( n ) + {b}_{1} * {res}_{lb} ( n - 1 ) - {a}_{0} * {res}_{lb}^{\hat{}} ( n - 1 )$$

$${b}_{0} = \frac{G * Ω + 1}{Ω + 1}$$

$${b}_{0} = \frac{G * Ω - 1}{Ω + 1}$$

$${a}_{0} = \frac{Ω - 1}{Ω + 1}$$

$$Ω = tan \frac{π {f}_{c}}{{f}_{s}}$$

where f_{c} represents a frequency that needs to be adjusted, G=1+B₀ represents a gain value under a corresponding frequency, and a frequency suppression range and a frequency suppression degree of the filter may be specified according to a spectrum tilt degree, thereby reducing the spectrum tilt degree of the low-frequency residual.

S309: inverting a frequency component in the encoded suppression signal meeting a preset condition to acquire a spectrum inversion signal.

Similarly, after the frequency division is performed on the audio signal by the quadrature mirror filter, the spectrum of the obtained high-frequency signal is inverted, and in order to ensure that the spectrum of the spectrum inversion signal corresponds to an original high-frequency spectrum, it is necessary to perform spectrum inversion on the low-frequency residual signal. The implementation of performing spectrum inversion on the encoded suppression signal is the same as that in the step S209, and thus details are not described herein again.

S310: acquiring a high-frequency energy gain of the target audio signal according to the spectrum inversion signal and the high-frequency residual signal.

The implementation of the above step S310 may be the same as the implementation of the step S210 in the embodiment shown in FIG. 2, and thus details are not described herein again to avoid repetition.

S311: encoding the low-frequency encoding information, the LSP coefficient and the high-frequency energy gain to generate encoded data of the target audio frame.

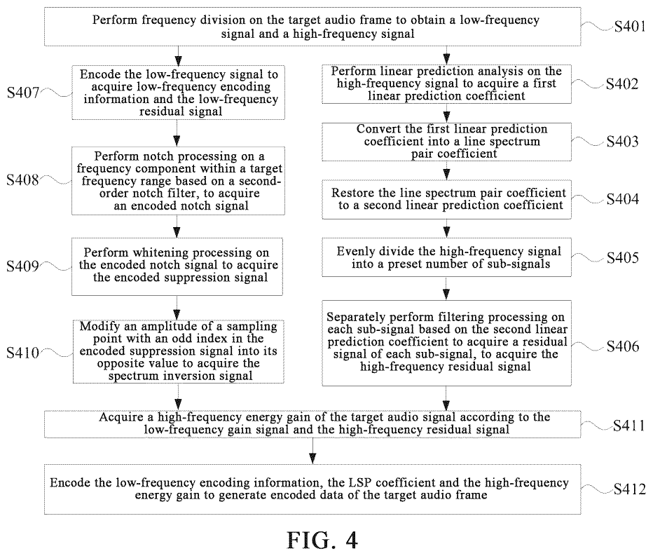

An embodiment of the present application provides another audio signal encoding method, and as shown in FIG. 4, the audio signal encoding method includes the following steps:

S401: performing frequency division on the target audio frame to obtain a low-frequency signal and a high-frequency signal.

S402: performing linear prediction analysis on the high-frequency signal to acquire a first linear prediction coefficient.

S403: converting the first linear prediction coefficient into a line spectrum pair coefficient.

S404: restoring the line spectrum pair coefficient to a second linear prediction coefficient.

S405: evenly dividing the high-frequency signal into a preset number of sub-signals.

S406: separately performing filtering processing on each sub-signal based on the second linear prediction coefficient to acquire a residual signal of each sub-signal, to acquire the high-frequency residual signal.

S407: encoding the low-frequency signal to acquire low-frequency encoding information and the low-frequency residual signal.

The implementations of the above steps S401 to S407 may be the same as the implementations of the steps S201 to S207 in the embodiment shown in FIG. 2, and thus details are not described herein again to avoid repetition.

S408: performing notch processing on a frequency component within a target frequency range based on a second-order notch filter, to acquire an encoded notch signal.

That is, the fundamental-tone frequency of the low-frequency residual signal is first acquired, then the target frequency range is determined according to the fundamental-tone frequency of the low-frequency residual signal, and notch processing is performed on the frequency component within the target frequency range by using the second-order notch filter, to acquire the encoded notch signal.

Since the spectrum inversion signal mainly has a relatively high frequency component in the vicinity of the fundamental-tone frequency (within the target frequency range), the spectrum inversion signal is input into the second-order notch filter to perform notch processing on the frequency component within the target frequency range.

In some embodiments, a transfer function of the second-order notch filter may be as follows:

$$H ( z ) = \frac{{b}_{0} + {b}_{1} {z}^{- 1} + {b}_{2} {z}^{- 2}}{1 + {a}_{1} {z}^{- 1} + {a}_{2} {z}^{- 2}}$$

By using a difference equation, it is represented as:

$${res}_{lb}^{\hat{}} ( n ) = {b}_{0} * {res}_{lb} ( n ) + {b}_{1} * {res}_{lb} ( n - 1 ) + {b}_{2} * {res}_{lb} ( n - 2 ) - {a}_{1} * {res}_{lb}^{\hat{}} ( n - 1 ) - {a}_{2} * {res}_{lb}^{\hat{}} ( n - 1 )$$

where,

$${b}_{0} = \frac{1 + γ \cdot G}{1 + γ / G}$$

$${b}_{1} = {a}_{1} = \frac{- 2 cos ( {Ω}_{0} )}{1 + γ / G}$$

$${b}_{2} = \frac{1 - γ \cdot G}{1 + γ / G}$$

$${a}_{2} = \frac{1 - γ / G}{1 + γ / G}$$

$${a}_{0} = \frac{Ω - 1}{Ω + 1}$$

$$γ = G * tan f ( bw / 2 )$$

Where

$${res}_{lb}^{\hat{}} ( n )$$

represents the low-frequency residual signal which has been subjected to second-order notch processing, bw represents a notch bandwidth of the filter, Ω₀ represents a center frequency point of the notch filter, and G represents a notch gain value under a specified frequency.

S409: performing whitening processing on the encoded notch signal to acquire the encoded suppression signal.

That is, after the notch processing has been performed on the low-frequency residual signal, the whitening processing is further performed on a processing result.

In some embodiments, the implementation of performing the whitening processing on the encoded notch signal includes:

firstly, obtaining an LPC of the low-frequency residual signal by a burg algorithm.

Secondly, performing, by using the LPC, high-order LPC filtering on the encoded notch signal obtained by the processing in the above step, to obtain the encoded suppression signal.

For example, in a case where the high-order LPC filtering is 8-order, calculation may be performed by using the following formula:

$${res}_{hb}^{*} ( n ) = {res}_{lb}^{\hat{}} ( n ) - {\sum }_{i = 1}^{8} {a}_{i} * {res}_{lb}^{\hat{}} ( n - i )$$

S410: modifying an amplitude of a sampling point with an odd index in the encoded suppression signal into its opposite value to acquire a spectrum inversion signal.

S411: acquiring a high-frequency energy gain of the target audio signal according to the spectrum inversion signal and the high-frequency residual signal.

S412: encoding the low-frequency encoding information, the line spectrum pair coefficient and the high-frequency energy gain, to generate encoded data of the target audio frame.

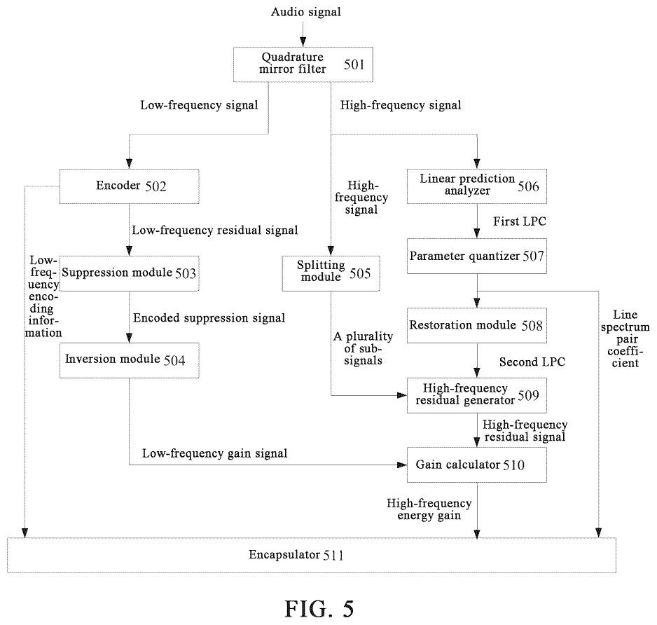

Referring to FIG. 5, FIG. 5 is a hardware block diagram of an audio signal encoding device provided in an embodiment of the present application, the audio signal encoding device includes: a quadrature mirror filter 501, an encoder 502, a suppression module 503, an inversion module 504, a splitting module 505, a linear prediction analyzer 506, a parameter quantizer 507, a restoration module 508, a high-frequency residual generator 509, a gain calculator 510, and an encapsulator 511.

The quadrature mirror filter 501 is configured to perform frequency division on a single frame of audio signal to obtain a low-frequency (low band, LB) signal and a high-frequency (high band, HB) signal.

The encoder 502 is configured to encode the low-frequency signal to generate low-frequency encoding information and a low-frequency residual signal.

The suppression module 503 is configured to suppress a frequency component within a target frequency range to acquire an encoded suppression signal, where a center frequency of the target frequency range is a fundamental-tone frequency of the low-frequency residual signal.

The inversion module 504 is configured to perform spectrum inversion on the encoded suppression signal to acquire a spectrum inversion signal.

The splitting module 505 is configured to equally divide a single frame of high-frequency signal into a preset number of sub-signals.

The linear prediction analyzer 506 is configured to perform linear prediction analysis on the high-frequency signal to acquire a first LPC of the high-frequency signal.

The parameter quantizer 507 is configured to convert the first linear prediction coefficient into an LSP coefficient.

The restoration module 508 is configured to restore the LSP coefficient to a second linear prediction coefficient.

The high-frequency residual generator 509 generates a residual signal of each sub-signal according to the second linear prediction coefficient and each sub-signal, to acquire a high-frequency residual signal.

The gain calculator 510 calculates a high-energy gain value according to the spectrum inversion signal and the high-frequency residual signal.

The encapsulator 511 is configured to encapsulate the low-frequency encoding information, the LSP coefficient and the high-frequency energy gain, to generate encoded data of an audio signal.

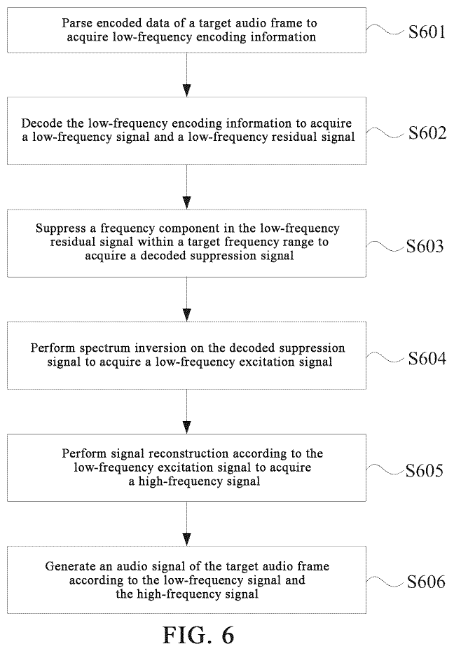

Another embodiment of the present application provides an audio signal decoding method, and as shown in FIG. 6, the audio signal decoding method includes the following steps:

S601: parsing encoded data of a target audio frame to acquire low-frequency encoding information.

That is, the received encoded data of the audio frame is decapsulated to acquire the low-frequency encoding information carried in the encoded data.

S602: decoding the low-frequency encoding information to acquire a low-frequency signal and a low-frequency residual signal.

In some embodiments, the low-frequency encoding information may be decoded by a decoder to acquire the low-frequency signal and the low-frequency residual signal.

S603: suppressing a frequency component in the low-frequency residual signal within a target frequency range to acquire a decoded suppression signal.

A center frequency of the target frequency range is a fundamental-tone frequency of the low-frequency residual signal.

S604: performing spectrum inversion on the decoded suppression signal to acquire a low-frequency excitation signal.

S605: performing signal reconstruction according to the low-frequency excitation signal to acquire a high-frequency signal.

S606: generating an audio signal of the target audio frame according to the low-frequency signal and the high-frequency signal.

In the audio signal decoding method provided in the embodiment of the present application, the low-frequency encoding information is acquired by parsing the encoded data of the target audio frame, the low-frequency encoding information is decoded to acquire the low-frequency signal and the low-frequency residual signal, the frequency component in the low-frequency residual signal within the target frequency range is suppressed, spectrum inversion is performed on the acquired decoded suppression signal to acquire the low-frequency excitation signal, then signal reconstruction is performed according to the low-frequency excitation signal to acquire the high-frequency signal, and finally, the audio signal of the target audio frame is generated according to the low-frequency signal and the high-frequency signal. In the embodiment of the present application, by suppressing the spectrum of the low-frequency excitation signal without attenuating the high-frequency signal, the problem of relatively low energy of the high-frequency signal is avoided; and in the embodiment of the present application, when the high-frequency signal is reconstructed, a spectrum value of a sampling point meeting a preset condition is inverted, thereby avoiding the problem that the high-frequency signal lacks a harmonic component. In conclusion, in the embodiment of the present application, when the high-frequency signal is reconstructed on a decoding end, relatively low high-frequency energy and the lack of high-frequency harmonics may be avoided, so that the embodiment of the present application can improve the audio quality.

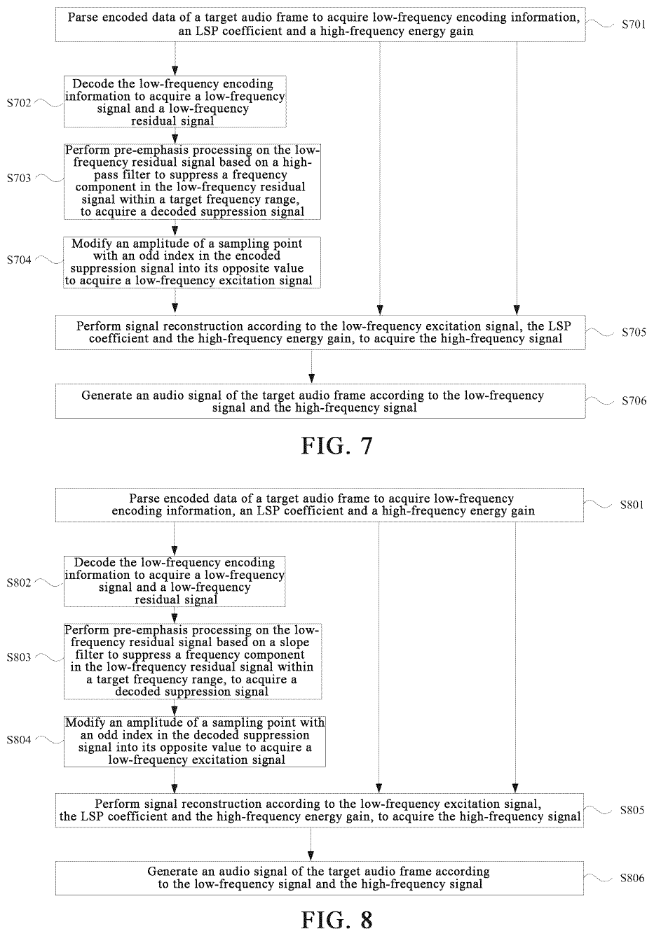

An embodiment of the present application provides another audio signal decoding method, and as shown in FIG. 7, the audio signal decoding method includes the following steps:

S701: parsing encoded data of a target audio frame to acquire low-frequency encoding information, an LSP coefficient and a high-frequency energy gain.

S702: decoding the low-frequency encoding information to acquire a low-frequency signal and a low-frequency residual signal.

S703: performing pre-emphasis processing on the low-frequency residual signal based on a high-pass filter to suppress a frequency component in the low-frequency residual signal within a target frequency range, to acquire a decoded suppression signal.

S704: modifying an amplitude of a sampling point with an odd index in the decoded suppression signal into its opposite value to acquire a low-frequency excitation signal.

S705: performing signal reconstruction according to the low-frequency excitation signal, the LSP coefficient and the high-frequency energy gain, to acquire the high-frequency signal.

Performing signal reconstruction according to the low-frequency excitation signal, the LSP coefficient and the high-frequency energy gain to acquire the high-frequency signal includes the following steps 1 to 6:

Step 1: acquiring an energy gain corresponding to each sub-signal in the high-frequency energy gain.

Step 2: acquiring a residual signal of each sub-signal according to the low-frequency excitation signal and the energy gain of each sub-signal.

Step 3: restoring the LSP coefficient to an LPC.

Step 4: acquiring each prediction sub-signal according to the LPC.

Step 5: generating each sub-signal according to each prediction sub-signal and the residual signal of each sub-signal.

Step 6: generating the high-frequency signal according to each sub-signal.

S706: generating an audio signal of the target audio frame according to the low-frequency signal and the high-frequency signal.

In some embodiments, the low-frequency signal and the high-frequency signal may be synthesized by using a quadrature mirror filter to generate the audio signal of the target audio frame.

An embodiment of the present application provides another audio signal decoding method, as shown in FIG. 8, a frequency component within a target frequency range in a low-frequency residual signal is suppressed to acquire a decoded suppression signal, and the audio signal decoding method includes the following steps:

S801: parsing encoded data of a target audio frame to acquire low-frequency encoding information, an LSP coefficient and a high-frequency energy gain.

S802: decoding the low-frequency encoding information to acquire a low-frequency signal and a low-frequency residual signal.

S803: performing filtering processing on the low-frequency residual signal based on a slope filter to suppress a frequency component in the low-frequency residual signal within a target frequency range, to acquire a decoded suppression signal.

S804: modifying an amplitude of a sampling point with an odd index in the decoded suppression signal into its opposite value to acquire a low-frequency excitation signal.

S805: performing signal reconstruction according to the low-frequency excitation signal, the LSP coefficient and the high-frequency energy gain, to acquire the high-frequency signal.

S806: generating an audio signal of the target audio frame according to the low-frequency signal and the high-frequency signal.

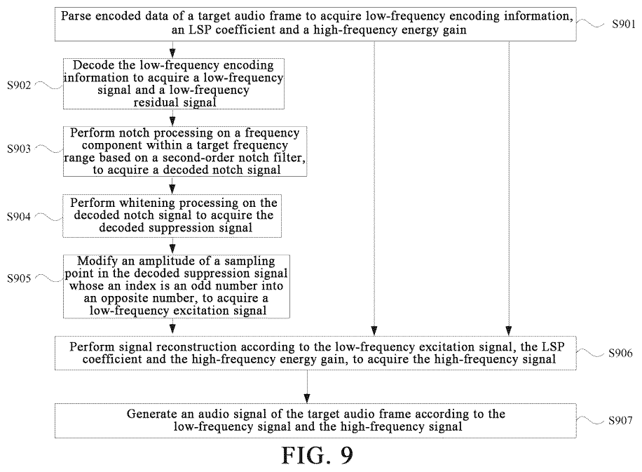

An embodiment of the present application provides another audio signal decoding method, as shown in FIG. 9, a frequency component within a target frequency range in a low-frequency residual signal is suppressed to acquire a decoded suppression signal, and the audio signal decoding method includes the following steps:

S901: parsing encoded data of a target audio frame to acquire low-frequency encoding information, an LSP coefficient and a high-frequency energy gain.

S902: decoding the low-frequency encoding information to acquire a low-frequency signal and a low-frequency residual signal.

S903: performing notch processing on a frequency component within a target frequency range based on a second-order notch filter, to acquire a decoded notch signal.

S904: performing whitening processing on the decoded notch signal to acquire the decoded suppression signal.

S905: modifying an amplitude of a sampling point with an odd index in the decoded suppression signal into its opposite value to acquire a low-frequency excitation signal.

S906: performing signal reconstruction according to the low-frequency excitation signal, the LSP coefficient and the high-frequency energy gain, to acquire the high-frequency signal.

S907: generating an audio signal of the target audio frame according to the low-frequency signal and the high-frequency signal.

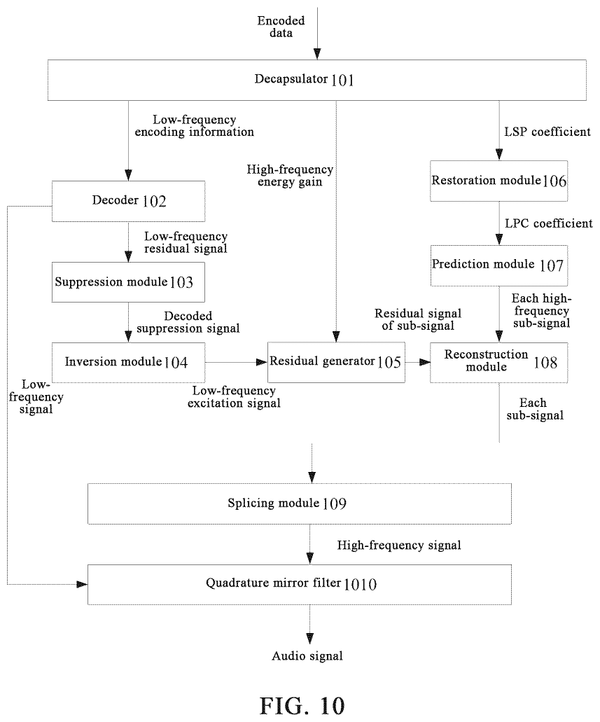

In combination with the above embodiments, referring to FIG. 10, FIG. 10 is a hardware block diagram of an audio signal decoding device provided in an embodiment of the present application. The decoding device includes: a decapsulator 101, a decoder 102, a suppression module 103, an inversion module 104, a residual generator 105, a restoration module 106, a prediction module 107, a reconstruction module 108, a splicing module 109, and a quadrature mirror filter 1010.

The decapsulator 101 is configured to acquire, by parsing, low-frequency encoding information, an LSP coefficient and a high-frequency energy gain.

The decoder 102 is configured to decode the low-frequency encoding information to acquire a low-frequency signal and a low-frequency residual signal.

The suppression module 103 is configured to suppress a frequency component within a target frequency range to acquire a decoded suppression signal, where a center frequency of the target frequency range is a fundamental-tone frequency of the low-frequency residual signal.

The inversion module 104 is configured to perform spectrum inversion on the decoded suppression signal to acquire a low-frequency excitation signal.

The residual generator 105 is configured to acquire a residual signal of each sub-signal according to the low-frequency excitation signal and an energy gain corresponding to each sub-signal in the high-frequency energy gain.

The restoration module 106 is configured to restore the LSP coefficient to an LPC.

The prediction module 107 is configured to acquire each high-frequency sub-signal according to the LPC.

The reconstruction module 108 is configured to generate each sub-signal according to each prediction sub-signal and the residual signal of each sub-signal.

The splicing module 109 is configured to splice the sub-signals into a high-frequency signal.

The quadrature mirror filter 1010 is configured to synthesize the high-frequency signal and the low-frequency signal into an audio signal.

Based on the same inventive concept, as an implementation of the above method, an embodiment of the present application further provides an audio signal encoding apparatus and an audio signal decoding apparatus. The embodiment corresponds to the foregoing method embodiments, for ease of reading, the detailed content in the foregoing method embodiments will not be repeated one by one in the embodiments of the present application, however, it should be clarified that the audio signal decoding apparatus and the audio signal encoding apparatus in the embodiments of the present application may correspond to all the content in the foregoing method embodiments.

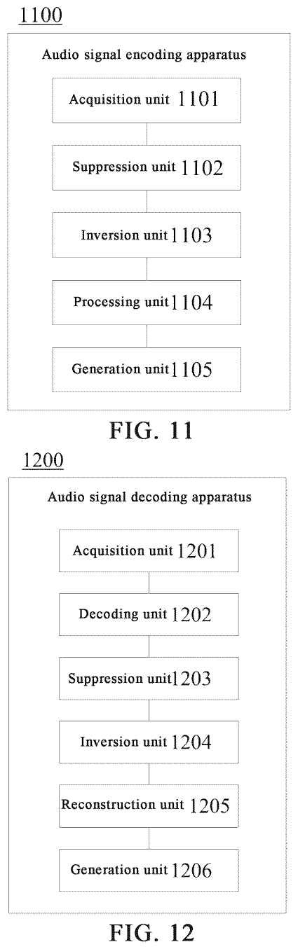

Based on the same concept, an embodiment of the present application provides an audio signal encoding apparatus, FIG. 11 is a schematic structural diagram of the audio signal encoding apparatus, and as shown in FIG. 11, the audio signal encoding apparatus 1100 includes:
an acquisition unit 1101, configured to acquire a high-frequency residual signal and a low-frequency residual signal of a target audio frame;
a suppression unit 1102, configured to suppress a frequency component in the low-frequency residual signal within a target frequency range to acquire an encoded suppression signal, where a center frequency of the target frequency range is a fundamental-tone frequency of the low-frequency residual signal;
an inversion unit 1103, configured to perform spectrum inversion on the encoded suppression signal to acquire a spectrum inversion signal;
a processing unit 1104, configured to acquire a high-frequency energy gain of the target audio signal according to the spectrum inversion signal and the high-frequency residual signal; and
a generation unit 1105, configured to generate encoded data of the target audio frame according to the high-frequency energy gain.

As an optional implementation of the embodiment of the present application, the suppression unit 1102 is specifically configured to:
perform pre-emphasis processing on the low-frequency residual signal based on a high-pass filter to suppress the frequency component in the low-frequency residual signal within the target frequency range, to acquire the encoded suppression signal.

As an optional implementation of the embodiment of the present application, the suppression unit 1102 is specifically configured to perform filtering processing on the low-frequency residual signal based on a slope filter to suppress the frequency component in the low-frequency residual signal within the target frequency range, to acquire the encoded suppression signal.

As an optional implementation of the embodiment of the present application, the suppression unit 1102 is specifically configured to perform notch processing on the frequency component within the target frequency range based on a second-order notch filter to acquire an encoded notch signal, and perform whitening processing on the encoded notch signal to acquire the encoded suppression signal.

As an optional implementation of the embodiment of the present application, the inversion unit 1103 is specifically configured to modify an amplitude of a sampling point with an odd index in the encoded suppression signal into its opposite value to acquire the spectrum inversion signal.

As an optional implementation of the embodiment of the present application, the acquisition unit 1104 is specifically configured to perform frequency division on the target audio frame to obtain a low-frequency signal and a high-frequency signal; perform linear prediction analysis on the high-frequency signal to acquire a first linear prediction coefficient (LPC); convert the first linear prediction coefficient into a line spectrum pair (LSP) coefficient; restore the line spectrum pair coefficient to a second linear prediction coefficient; evenly divide the high-frequency signal into a preset number of sub-signals; separately perform filtering processing on each sub-signal based on the second linear prediction coefficient to acquire a residual signal of each sub-signal, to acquire the high-frequency residual signal; and encode the low-frequency signal to acquire low-frequency encoding information and the low-frequency residual signal.

As an optional implementation of the embodiment of the present application, the generation unit 1105 is specifically configured to encode the low-frequency encoding information, the line spectrum pair coefficient and the high-frequency energy gain to generate the encoded data of the target audio frame.

The audio signal encoding apparatus provided in the embodiment of the present application may execute the audio signal encoding method provided in the above method embodiments, and the implementation principles and technical effects thereof are similar, thus details are not described herein again.

Based on the same concept, an embodiment of the present application provides an audio signal decoding apparatus, FIG. 12 is a schematic structural diagram of the audio signal decoding apparatus, and as shown in FIG. 12, the audio signal decoding apparatus 1200 includes:
an acquisition unit 1201, configured to parse encoded data of a target audio frame to acquire low-frequency encoding information;
a decoding unit 1202, configured to decode the low-frequency encoding information to acquire a low-frequency signal and a low-frequency residual signal;
a suppression unit 1203, configured to suppress a frequency component in the low-frequency residual signal within a target frequency range to acquire a decoded suppression signal, where a center frequency of the target frequency range is a fundamental-tone frequency of the low-frequency residual signal;
an inversion unit 1204, configured to perform spectrum inversion on the decoded suppression signal to acquire a low-frequency excitation signal;
a reconstruction unit 1205, configured to perform signal reconstruction according to the low-frequency excitation signal to acquire a high-frequency signal; and
a generation unit 1206, configured to generate an audio signal of the target audio frame according to the low-frequency signal and the high-frequency signal.

As an optional implementation of the embodiment of the present application, the suppression unit 1203 is specifically configured to perform pre-emphasis processing on the low-frequency residual signal based on a high-pass filter to suppress the frequency component in the low-frequency residual signal within the target frequency range, to acquire the decoded suppression signal.

As an optional implementation of the embodiment of the present application, the suppression unit 1203 is specifically configured to perform filtering processing on the low-frequency residual signal based on a slope filter to suppress the frequency component in the low-frequency residual signal within the target frequency range, to acquire the decoded suppression signal.

As an optional implementation of the embodiment of the present application, the suppression unit 1203 is specifically configured to perform notch processing on the frequency component within the target frequency range based on a second-order notch filter to acquire an encoded notch signal, and perform whitening processing on the decoded notch signal to acquire the decoded suppression signal.

As an optional implementation of the embodiment of the present application, the inversion unit 1204 is specifically configured to modify an amplitude of a sampling point with an odd index in the decoded suppression signal into its opposite value to acquire a low-frequency excitation signal.

As an optional implementation of the embodiment of the present application, the encoded data of the target audio frame further includes an LSP coefficient and a high-frequency energy gain, and the reconstruction unit 1205 is specifically configured to perform signal reconstruction according to the low-frequency excitation signal, the LSP coefficient and the high-frequency energy gain, to acquire the high-frequency signal.

As an optional implementation of the embodiment of the present application, the reconstruction unit 1205 is specifically configured to acquire an energy gain corresponding to each sub-signal in the high-frequency energy gain; acquire a residual signal of each sub-signal according to the low-frequency excitation signal and the energy gain of each sub-signal; restore the LSP coefficient to an LPC; acquire each prediction sub-signal according to the LPC; generate each sub-signal according to each prediction sub-signal and the residual signal of each sub-signal; and generate the high-frequency signal according to each sub-signal.

The audio signal decoding apparatus provided in the embodiment of the present application may execute the audio signal decoding method provided in the above method embodiments, and the implementation principles and technical effects thereof are similar, thus details are not described herein again.

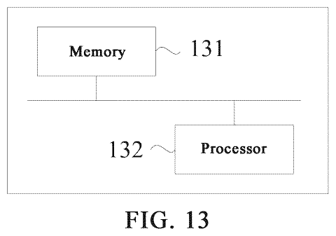

Based on the same inventive concept, an embodiment of the present application further provides an electronic device. FIG. 13 is a schematic structural diagram of an electronic device provided in an embodiment of the present application. As shown in FIG. 13, the electronic device provided in the embodiment of the present application includes a memory 131 and a processor 132, wherein the memory 131 is configured to store a computer program; and the processor 132 is configured to execute, when executing the computer program, the audio signal encoding method or the audio signal decoding method provided in the above embodiments.

Based on the same inventive concept, an embodiment of the present application further provides a computer-readable storage medium, storing a computer program thereon, wherein when the computer program is executed by a processor, a computing device is caused to implement the audio signal encoding method or the audio signal decoding method provided in the above embodiments.

Based on the same inventive concept, an embodiment of the present application further provides a computer program product, wherein when the computer program product runs on a computer, a computing device is caused to implement the audio signal encoding method or the audio signal decoding method provided in the above embodiments.

Those skilled in the art should understand that, the embodiments of the present application may be provided as a method, a system or a computer program product. Accordingly, the present application may adopt the form of a complete hardware embodiment, a complete software embodiment, or an embodiment combining software with hardware. Moreover, the present application may adopt the form of a computer program product, which is implemented on one or more computer-usable storage media including computer-usable program codes.

The processor may be a central processing unit (CPU), or may be another general-purpose processor, a digital signal processor (DSP), an application specific integrated circuit (ASIC), a field-programmable gate array (FPGA) or another programmable logic device, a discrete gate or a transistor logic device, a discrete hardware component, or the like. The general-purpose processor may be a microprocessor, or the processor may be any conventional processor, or the like.

The memory may include a volatile memory, a random access memory (RAM) and/or a non-volatile memory and other forms in a computer-readable medium, such as a read only memory (ROM) or a flash random access memory (flash RAM). The memory is an example of the computer-readable medium.

The computer-readable medium includes non-volatile and volatile, and removable and non-removable media. The storage medium may implement information storage by means of any method or technology, the information may be computer-readable instructions, data structures, program modules, or other data. Examples of the computer storage medium include, but are not limited to, a phase-change random access memory (PRAM), a static random access memory (SRAM), a dynamic random access memory (DRAM), other types of random access memories (RAMs), a read only memory (ROM), an electrically erasable programmable read only memory (EEPROM), a flash memory or other memory technologies, a compact disc-read only memory (CD-ROM), a digital versatile disc (DVD) or other optical memories, a magnetic cassette, a magnetic disk memory or other magnetic storage devices or any other non-transmission media, which may be used for storing information accessible by a computing device. According to the definition herein, the computer-readable medium does not include transitory media, such as modulated data signals and carriers.

Finally, it should be noted that the above embodiments are only used to illustrate the technical solutions of the present application, rather than limiting same. Although the present application has been described in detail with reference to the foregoing embodiments, those ordinary skilled in the art should understand that they could still make modifications to the technical solutions described in the foregoing embodiments or make equivalent substitutions to some or all of the technical features therein; and these modifications or substitutions do not make the essence of the corresponding technical solutions depart from the scope of the technical solutions of the embodiments of the present application.

1. An audio signal encoding method, comprising:
acquiring a high-frequency residual signal and a low-frequency residual signal of a target audio frame;
suppressing a frequency component in the low-frequency residual signal within a target frequency range to acquire an encoded suppression signal, wherein a center frequency of the target frequency range is a fundamental-tone frequency of the low-frequency residual signal;
performing spectrum inversion on the encoded suppression signal to acquire a spectrum inversion signal;
acquiring a high-frequency energy gain of the target audio signal according to the spectrum inversion signal and the high-frequency residual signal; and
generating encoded data of the target audio frame according to the high-frequency energy gain.

2. The method according to claim 1, wherein suppressing the frequency component in the low-frequency residual signal within the target frequency range to acquire the encoded suppression signal, comprises:
performing pre-emphasis processing on the low-frequency residual signal based on a high-pass filter to suppress the frequency component in the low-frequency residual signal within the target frequency range, to acquire the encoded suppression signal.

3. The method according to claim 1, wherein suppressing the frequency component in the low-frequency residual signal within the target frequency range to acquire the encoded suppression signal, comprises:
performing filtering processing on the low-frequency residual signal based on a slope filter to suppress the frequency component in the low-frequency residual signal within the target frequency range, to acquire the encoded suppression signal.

4. The method according to claim 1, wherein suppressing the frequency component in the low-frequency residual signal within the target frequency range to acquire the encoded suppression signal comprises:
performing notch processing on the frequency component within the target frequency range based on a second-order notch filter, to acquire an encoded notch signal; and
performing whitening processing on the encoded notch signal to acquire the encoded suppression signal.

5. The method according to claim 1, wherein performing spectrum inversion on the encoded suppression signal to acquire the spectrum inversion signal comprises:
modifying an amplitude of a sampling point with an odd index in the encoded suppression signal into its opposite value to acquire the spectrum inversion signal.

6. The method according to claim 1, wherein acquiring the high-frequency residual signal and the low-frequency residual signal of the target audio frame comprises:
performing frequency division on the target audio frame to obtain a low-frequency signal and a high-frequency signal;
performing linear prediction analysis on the high-frequency signal to acquire a first linear prediction coefficient (LPC);
converting the first linear prediction coefficient into a line spectrum pair (LSP) coefficient;
restoring the line spectrum pair coefficient to a second linear prediction coefficient;
evenly dividing the high-frequency signal into a preset number of sub-signals;
separately performing filtering processing on each sub-signal based on the second linear prediction coefficient to acquire a residual signal of each sub-signal and acquire the high-frequency residual signal; and
encoding the low-frequency signal to acquire low-frequency encoding information and the low-frequency residual signal.

7. The method according to claim 6, wherein generating the encoded data of the target audio frame according to the high-frequency energy gain comprises:
encoding the low-frequency encoding information, the line spectrum pair coefficient and the high-frequency energy gain to generate the encoded data of the target audio frame.

8. An audio signal decoding method, comprising:
parsing encoded data of a target audio frame to acquire low-frequency encoding information;
decoding the low-frequency encoding information to acquire a low-frequency signal and a low-frequency residual signal;
suppressing a frequency component in the low-frequency residual signal within a target frequency range to acquire a decoded suppression signal, wherein a center frequency of the target frequency range is a fundamental-tone frequency of the low-frequency residual signal;
performing spectrum inversion on the decoded suppression signal to acquire a low-frequency excitation signal;
performing signal reconstruction according to the low-frequency excitation signal to acquire a high-frequency signal; and
generating an audio signal of the target audio frame according to the low-frequency signal and the high-frequency signal.

9. The method according to claim 8, wherein suppressing the frequency component in the low-frequency residual signal within the target frequency range to acquire the decoded suppression signal comprises:
performing pre-emphasis processing on the low-frequency residual signal based on a high-pass filter to suppress the frequency component in the low-frequency residual signal within the target frequency range, to acquire the decoded suppression signal.

10. The method according to claim 8, wherein suppressing the frequency component in the low-frequency residual signal within the target frequency range to acquire the decoded suppression signal comprises:
performing filtering processing on the low-frequency residual signal based on a slope filter to suppress the frequency component in the low-frequency residual signal within the target frequency range, to acquire the decoded suppression signal.

11. The method according to claim 8, wherein suppressing the frequency component in the low-frequency residual signal within the target frequency range, to acquire the decoded suppression signal, comprises:
performing notch processing on the frequency component within the target frequency range based on a second-order notch filter, to acquire a decoded notch signal; and
performing whitening processing on the decoded notch signal to acquire the decoded suppression signal.

12. The method according to claim 8, wherein inverting a spectrum value of a sampling point in the decoded suppression signal meeting a preset condition, to acquire the spectrum inversion signal comprises:
modifying an amplitude of a sampling point with an odd index in the decoded suppression signal into its opposite value, to acquire the low-frequency excitation signal.

13. The method according to claim 8, wherein the encoded data of the target audio frame further comprises an LSP coefficient and a high-frequency energy gain; and
performing signal reconstruction according to the low-frequency excitation signal to acquire the high-frequency signal comprises:
performing signal reconstruction according to the low-frequency excitation signal, the LSP coefficient and the high-frequency energy gain, to acquire the high-frequency signal.

14. The method according to claim 13, wherein performing signal reconstruction according to the low-frequency excitation signal, the LSP coefficient and the high-frequency energy gain, to acquire the high-frequency signal, comprises:
acquiring an energy gain corresponding to each sub-signal in the high-frequency energy gain;
acquiring a residual signal of each sub-signal according to the low-frequency excitation signal and the energy gain of each sub-signal;
restoring the LSP coefficient to an LPC;
acquiring each prediction sub-signal according to the LPC;
generating each sub-signal according to each prediction sub-signal and the residual signal of each sub-signal; and
generating the high-frequency signal according to each sub-signal.

15-16. (canceled)

17. An electronic device, comprising a memory and a processor, wherein the memory is configured to store a computer program; and the processor is configured to, when executing the computer program, cause the electronic device to:
acquire a high-frequency residual signal and a low-frequency residual signal of a target audio frame;
suppress a frequency component in the low-frequency residual signal within a target frequency range to acquire an encoded suppression signal, wherein a center frequency of the target frequency range is a fundamental-tone frequency of the low-frequency residual signal;
perform spectrum inversion on the encoded suppression signal to acquire a spectrum inversion signal;
acquire a high-frequency energy gain of the target audio signal according to the spectrum inversion signal and the high-frequency residual signal; and
generate encoded data of the target audio frame according to the high-frequency energy gain;
or,
parse encoded data of a target audio frame to acquire low-frequency encoding information;
decode the low-frequency encoding information to acquire a low-frequency signal and a low-frequency residual signal;
suppress a frequency component in the low-frequency residual signal within a target frequency range to acquire a decoded suppression signal, wherein a center frequency of the target frequency range is a fundamental-tone frequency of the low-frequency residual signal;
perform spectrum inversion on the decoded suppression signal to acquire a low-frequency excitation signal;
perform signal reconstruction according to the low-frequency excitation signal to acquire a high-frequency signal; and
generate an audio signal of the target audio frame according to the low-frequency signal and the high-frequency signal.

18-19. (canceled)

20. The electronic device method according to claim 17, wherein the electronic device is caused to suppress the frequency component in the low-frequency residual signal within the target frequency range to acquire the encoded suppression signal by being caused to:
perform pre-emphasis processing on the low-frequency residual signal based on a high-pass filter to suppress the frequency component in the low-frequency residual signal within the target frequency range, to acquire the encoded suppression signal.

21. The electronic device according to claim 17, wherein the electronic device is caused to suppress the frequency component in the low-frequency residual signal within the target frequency range to acquire the encoded suppression signal by being caused to:
perform filtering processing on the low-frequency residual signal based on a slope filter to suppress the frequency component in the low-frequency residual signal within the target frequency range, to acquire the encoded suppression signal.

22. The electronic device according to claim 17, wherein the electronic device is caused to suppress the frequency component in the low-frequency residual signal within the target frequency range to acquire the encoded suppression signal by being caused to:
perform notch processing on the frequency component within the target frequency range based on a second-order notch filter, to acquire an encoded notch signal; and
perform whitening processing on the encoded notch signal to acquire the encoded suppression signal.

23. The electronic device according to claim 17, wherein the electronic device is caused to perform spectrum inversion on the encoded suppression signal to acquire the spectrum inversion signal comprises:
modify an amplitude of a sampling point with an odd index in the encoded suppression signal into its opposite value to acquire the spectrum inversion signal.

24. The electronic device according to claim 17, wherein the electronic device is caused to acquire the high-frequency residual signal and the low-frequency residual signal of the target audio frame by being caused to:
perform frequency division on the target audio frame to obtain a low-frequency signal and a high-frequency signal;
perform linear prediction analysis on the high-frequency signal to acquire a first linear prediction coefficient (LPC);
convert the first linear prediction coefficient into a line spectrum pair (LSP) coefficient;
restore the line spectrum pair coefficient to a second linear prediction coefficient;
evenly divide the high-frequency signal into a preset number of sub-signals;
separately perform filtering processing on each sub-signal based on the second linear prediction coefficient to acquire a residual signal of each sub-signal and acquire the high-frequency residual signal; and
encode the low-frequency signal to acquire low-frequency encoding information and the low-frequency residual signal.
